(19) United States
(12) Patent Application Publication
(10) Pub. No.: US 2022/0181820 A1
(43) Pub. Date: Jun. 9, 2022

(54) ELECTRICAL EXTENSION CORD DEVICE

(71) Applicant: THE NOCO COMPANY, Glenwillow, OH (US)

(72) Inventors: Jonathan Lewis NOOK, Gates Mills, OH (US); William Knight NOOK, SR., Shaker Heights, OH (US); James Richard STANFIELD, Glendale, AZ (US); Derek Michael UNDERHILL, Tempe, AZ (US)

(73) Assignee: THE NOCO COMPANY, Glenwillow, OH (US)

(21) Appl. No.: 17/593,019

(22) PCT Filed: Mar. 6, 2020
(86) PCT No.: PCT/US2020/021487

§ 371 Date: Sep. 3, 2021

Related U.S. Application Data
(60) Provisional application No. 62/815,041, filed on Mar. 7, 2019.
(60) Provisional application No. 62/815,875, filed on Mar. 8, 2019.
(60) Provisional application No. 62/816,636, filed on Mar. 11, 2019.
(60) Provisional application No. 62/816,793, filed on Mar. 11, 2019.

(51) Int. Cl. H01R 13/52; H01R 24/22; H01R 24/70; H01R 13/50

(52) U.S. Cl. CPC H01R 13/5213; H01R 24/22; H01R 2103/00; H01R 13/50; H01R 13/5227; H01R 24/70

(57) ABSTRACT

An electrical extension cord device having an electrical port at one end and an electrical connector at an opposite end. The electrical port can include a cap or cover removable connected to the electrical port having an electrical plug or receptacle. The cap or cover and the electrical port have cooperating sealing surfaces to ensure watertight or waterproof sealing when the cap or cover is installed “on” the electrical port to prevent water or moisture reaching the plug.

### FIELD

The present invention is directed to an electrical extension cord device, for example, an AC electrical extension cord device having an electrical port.

### BACKGROUND

U.S. Pat. No. D684,929 discloses an AC port. There exists a need for an electrical extension cord device with an electrical port, for example, an AC port.

### SUMMARY

The present invention is directed to an electrical extension cord device. For example, the electrical extension cord device according to the present invention includes an electrical port. The electrical port, for example, can be provided with a removable cap or cover. The electrical port is provided with a receptacle receiving an electrical connector (e.g. electrical plug, electrical receptacle). The electrical extension cord device further includes an electrical cord or cable connecting the electrical port to an electrical connector (e.g. electrical receptacle, electrical plug). The electrical cord or cable is sufficiently long to allow the electrical port to be separated from the electrical connector at least a predetermined distance (e.g. two (2) feet to 200 feet or more). For example, the electrical cord or cable can be at least 10 feet, 25 feet, 50 feet, 75 feet, 100 feet, and over 100 feet in length, or 2 meters, 4 meters, 6 meters, 8 meters, 10 meters, and over 10 meters).

The electrical port and the removable cap or cover, for example, are configured to provide a water tight seal between the electrical port and the removable cap or cover when the removable cap or cover is installed “on” the electrical port to prevent water or moisture from entering the receptacle of the electrical port. The electrical port includes a flange surrounding the receptacle of the electrical port.

An enhanced water tight seal is achieved by providing an elevated ring-shaped ridge having an elevated flat ring-shaped surface on the front face of the flange of the electrical port. Specifically, the ring-shaped ridge is elevated a predetermined distance above the front face surface of the electrical port. This arrangement reduces the size of the sealing area of the flat ring-shaped surface of the ring-shaped ridge to concentrate the sealing force between the cap or cover and the ring-shaped ridge to a smaller sealing area. Further, the inner and outer edges of the ring-shaped ridge can press into the soft or resilient material of the cap or cover so that the inner and outer edges more effectively seal the cap or cover with the ring-shaped ridge.

The electrical connector (e.g. receptacle) is connected to the electrical port via the electrical cord or cable. The electrical connector can be provided with one or more protrusions to enhance the ability of a user to grip, and connect or disconnect the electrical connector with another electrical connector. For example, an X-shaped protrusion can be provided on the electrical connector to allow a user to grip the electrical connector with his or her fingers to connect or disconnect the electrical connector with another connector.

The presently described subject matter is directed to an electrical extension cord device.

The presently described subject matter is directed to an electrical extension cord device having an electrical port.

The presently described subject matter is directed to an electrical extension cord device having an electrical port with an electrical connector (e.g. plug or receptacle) located at one end of an electrical cord or cable and an electrical connector (e.g. receptacle or plug) located at an opposite end of the electrical cord or cable.

The presently described subject matter is directed to an improved AC extension cord device with electrical port.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector.

The presently described subject matter is directed to an electrical extension cord device comprising or consisting of: an electrical port having a housing provided with a receptacle and a flange surrounding the receptacle; an electrical plug disposed within the receptacle; a cover removable disposed within the receptacle to cover and uncover the plug; an electrical connector; and an electrical extension cord or cable electrically connecting together the electrical port and the electrical connector.

The presently described subject matter is directed to an electrical extension cord or cable device, comprising: an electrical port having a housing provided with a receptacle and a flange surrounding the receptacle; an electrical plug disposed within the receptacle; a cover removable disposed within the receptacle to cover and uncover the plug; an electrical receptacle; an extension cord or cable electrically connecting together the electrical port and the electrical receptacle.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the electrical connector is provided with one or more slots to provide a flexible connection with the electrical extension cord or cable.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the electrical connector is provided with a protrusion to enhance gripping of the electrical cord or cable connector by a user.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the flange has a circular-shaped sealing ridge and the cover includes an inner circular-shaped sealing surface for sealingly cooperating with the circular-shaped sealing ridge of the flange of the electrical port.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the flange has a circular-shaped sealing ridge and the cover includes an inner circular-shaped sealing surface for sealingly cooperating with the circular-shaped sealing ridge of the flange of the electrical port, and wherein the circular-shaped sealing ridge of the flange of the electrical port is provided with a flat sealing face.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the flange has a circular-shaped sealing ridge and the cover includes an inner circular-shaped sealing surface for sealingly cooperating with the circular-shaped sealing ridge of the flange of the electrical port, wherein the flat sealing face of the circular-shaped sealing ridge is elevated a predetermined distance above an outer face of the flange of the electrical port.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, further comprising a gasket provided on an inner side of the flange of the electrical port.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, further comprising a gasket provided on an inner side of the flange of the electrical port, wherein the cover or cap is connected to the gasket.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, further comprising a gasket provided on an inner side of the flange of the electrical port, wherein the cover or cap is connected to the gasket, wherein the cover or cap is connected to the gasket by a flexible connector.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, further comprising a gasket provided on an inner side of the flange of the electrical port, wherein the cover or cap is connected to the gasket, wherein the cover or cap is connected to the gasket by a flexible connector, wherein the cover, gasket, and flexible connector are constructed as a single piece.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the cover comprises a collar for fitting into the receptacle of the electrical port.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the cover comprises a collar for fitting into the receptacle of the electrical port, and wherein the collar comprises one or more outer ridges.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the housing is provided with a venting and/or drain hole.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the extension cord is at least three (3) feet in length.

The presently described subject matter is directed to an electrical extension cord or cable device, comprising and consisting of: an electrical port having a housing provided with a receptacle and a flange surrounding the receptacle; a cover removable disposed within the receptacle to cover and uncover the plug; an electrical plug disposed within the receptacle; an electrical connector; and an electrical extension cord or cable electrically connecting together the electrical port and the electrical connector, wherein the extension cord is at least one (1) meter in length.

The presently described subject matter is directed to an electrical extension cord device, comprising or consisting of: an electrical port having a housing with a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle.

The presently described subject matter is directed to an electrical extension cord device, comprising or consisting of: an electrical port having a flange surrounding a receptacle, the flange having a circular-shaped ridge with a flat face; an electrical plug disposed within the receptacle; a cover removable disposed within the receptacle to cover and uncover the plug, the cover including an inner circular-shaped sealing surface for sealingly cooperating with the flat face of the circular-shaped ridge of the flange of the electrical port; an electrical receptacle; and an electrical cord electrically connecting together the electrical port and the electrical receptacle.

The presently described subject matter is directed to an electrical extension cord device, comprising or consisting of: an electrical port having a housing with a flange surrounding a receptacle, the flange having a circular-shaped ridge with a flat sealing face; an electrical plug disposed within the receptacle; a cover removable disposed within the receptacle to cover and uncover the plug, the cover including a collar having one or more outer sealing ridges and an inner circular-shaped sealing surface for sealingly cooperating with the flat sealing face of the circular-shaped ridge of the flange of the electrical port; an electrical receptacle; and an electrical cord electrically connecting together the electrical port and the electrical receptacle.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, wherein the circular-shaped ridge of the flange of the electrical port is provided with a flat face.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, wherein the flat face of the circular-shaped ridge is elevated a predetermined distance above an outer face of the flange of the electrical port.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover is connected to the gasket.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover is connected to the gasket by a flexible connector.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover is connected to the gasket by a flexible connector, wherein the cover, gasket, and flexible connector are constructed as a single piece.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover comprises a collar for fitting into the receptacle of the electrical port.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover comprises a collar for fitting into the receptacle of the electrical port, wherein the collar comprises one or more outer ridges.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, wherein the receptacle is provided with a protrusion to facilitate gripping of the receptacle by a user.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, wherein the protrusion is an X-shaped protrusion.

The presently described subject matter is directed to an electrical extension cord device, comprising or consisting of: an electrical port having a flange surrounding a receptacle, the flange having a circular-shaped ridge; an electrical plug disposed within the receptacle; a cover removable disposed within the receptacle to cover and uncover the plug, the cover including an inner circular-shaped sealing surface for sealingly cooperating with the circular-shaped ridge of the flange of the electrical port; an electrical receptacle; and an electrical cord electrically connecting together the electrical port and the electrical receptacle, further comprising a gasket provided on an inner side of the flange of the electrical port, wherein the cover comprises a collar for fitting into the receptacle of the electrical port, wherein the housing is provided with a venting/drain hole.

### BRIEF DESCRIPTION OF DRAWINGS

FIG. 1 is a perspective view of an electrical extension cord device according to the present invention with the cap or cover “off.”

FIG. 2 is front view of the electrical extension cord device shown in FIG. 1.

FIG. 3 is a rear view of the electrical extension cord device shown in FIG. 1.

FIG. 4 is a right side elevational view of the electrical extension cord device shown in FIG. 1.

FIG. 5 is a left side elevational view of the electrical extension cord device shown in FIG. 1.

FIG. 6 is a top view of the electrical extension cord device shown in FIG. 1.

FIG. 7 is a bottom view of the electrical extension cord device shown in FIG. 1.

FIG. 8 is a perspective view of an electrical extension cord device according to the present invention with the cap or cover “on.”

### DETAILED DESCRIPTION

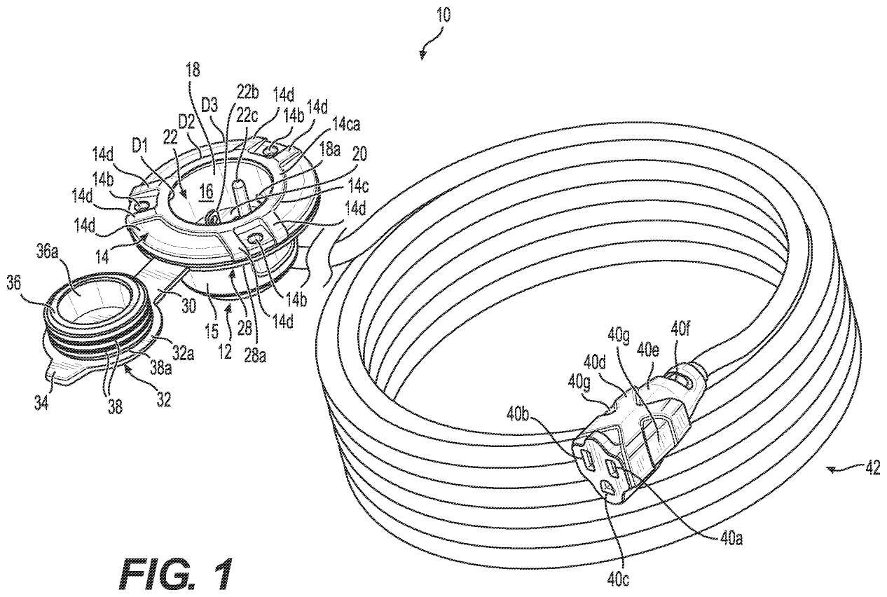

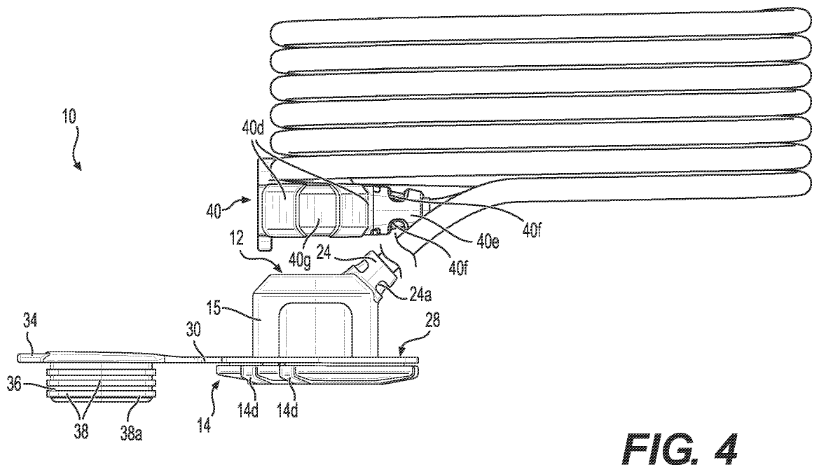

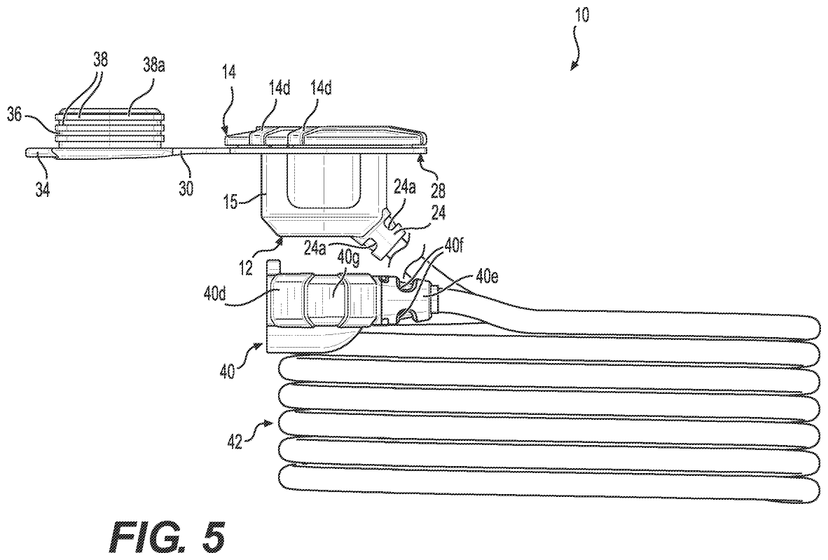

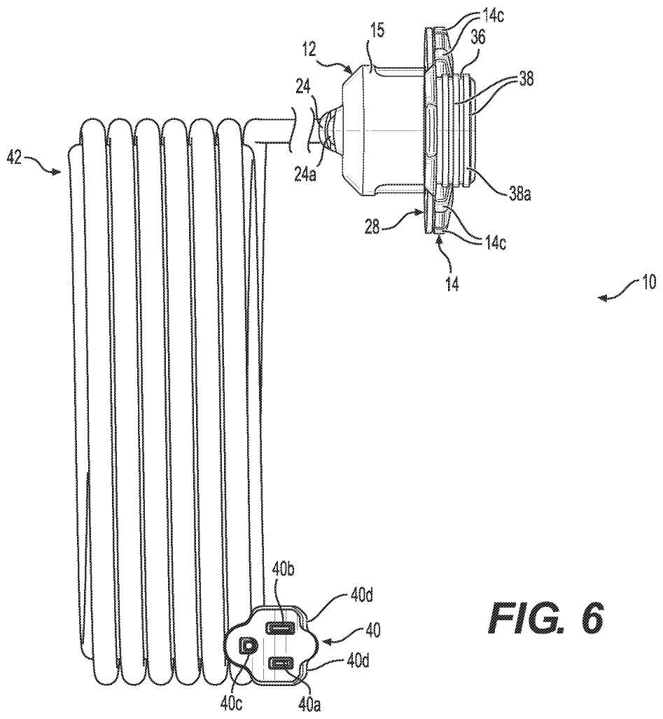

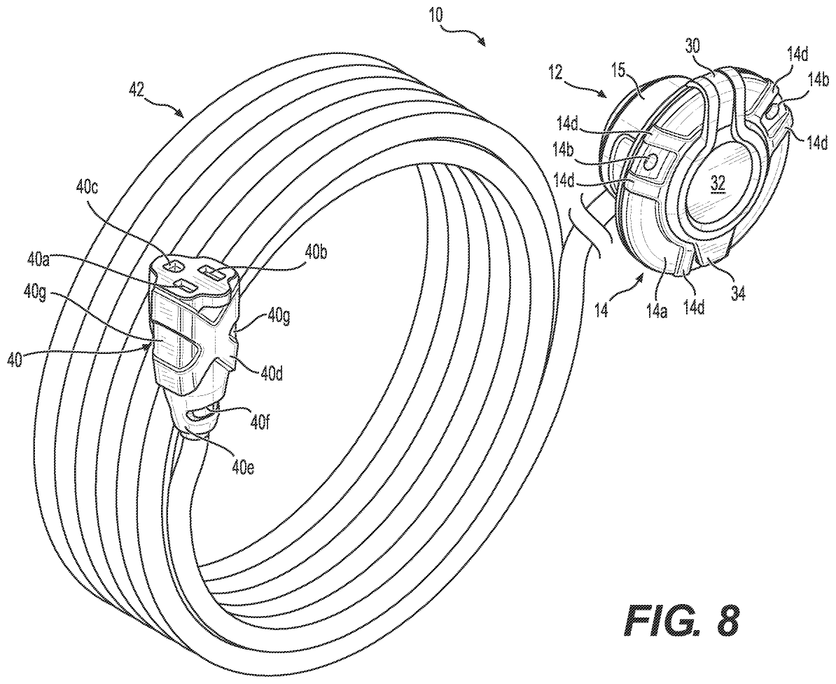

An electrical extension cord device 10 according to the present invention is shown in FIGS. 1-8.

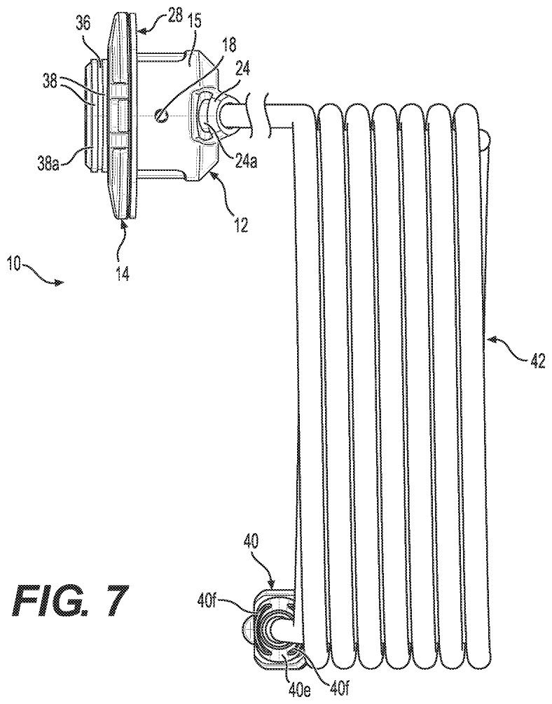

The electrical extension cord device 10 comprises an electrical port 12 having a flange 14 fixed to a housing 15. The housing 15 is provided with a receptacle 16 defined by a cylindrical-shaped wall 18 and a bottom wall 20. The cylindrical-shaped wall 18 is provided with a lower drain hole 18a (FIGS. 1 and 7) for venting the receptacle 16 and draining any water or moisture located within the receptacle 16 that drains to the lowest point in the receptacle 16 by gravity.

The flange 14 is provided with an outer face 14a and through holes 14b (FIG. 1) for accommodating a fastener (e.g. screws, rustproof screws, stainless steel screws, anodized aluminum screws) for mounting the electrical port 12, for example, into a hole provided in a wall or sheet.

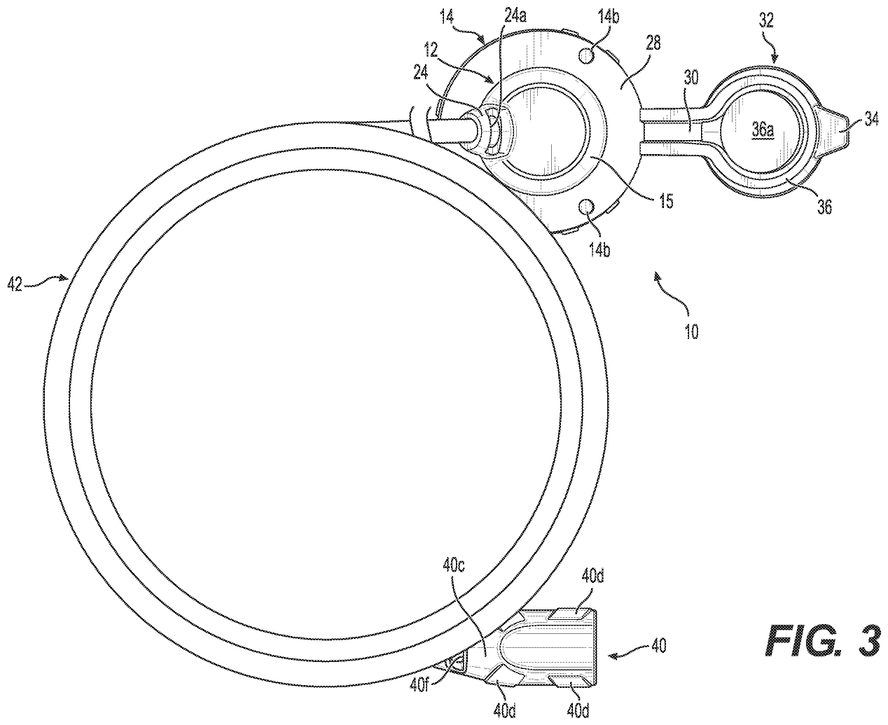

The receptacle 16 accommodates, for example, a male electrical connector such as an electrical plug 22 (i.e. male electrical connector) having a neutral prong 22a, an active prong 22b, and an earth prong 22c extending outwardly from the inner bottom wall 20 into the receptacle 16. The housing 15 of the electrical port 12 is provided with a wire sleeve 24 (FIG. 3) having slots 24a for making the wire sleeve 24 flexible or bendable. The wire sleeve 24, for example, can be a plastic injection molded sleeve fitted over the electrical cord or cable 42 and connected to the housing 15 of the electrical port 12 (e.g. snap fit, interference fit, mechanical fit, or adhesive fit).

A gasket 28 (e.g. resilient plastic injection molded flat flexible gasket) having an inner cylindrical-shaped hole is installed over the housing 15 onto the backside surface of the flange 14. For example, the gasket 28 fits between the flange 14 and a wall surface on which the electrical extension cord device 14 is installed. The gasket 28 comprises a ring 28a, a flexible connector 30, and a cap or cover 32 having a tab 34 and a cylindrical-shaped collar 36 provided with outer ring-shaped sealing ridges 38. The cylindrical-shaped collar 36 is provided with an inner cylindrical-shaped cavity 36a for accommodating the plug 22 when the cap or cover 32 is installed “on” the electrical port 12. The flexible connector 30 is sufficiently flexible so that the flexible connector 30 can be bent over 180° to install the cap or cover 32 “on” the receptacle 16 to seal the receptacle water tight. To remove the cap or cover 32, a user can grip the tab 34 to pull and remove (i.e. uninstall) the cap or cover 32 from the receptacle 16.

The electrical extension cord device 10 further comprises an electrical connector such as an electrical receptacle 40 (i.e. female connector). The electrical receptacle 40, for example, can be a plastic insert injection molded receptacle with electrical conductors, including a neutral prong receptacle 40a, an active prong receptacle 40b, and an earth prong receptacle 40c. The electrical receptacle 40 is connected to a three (3) wire electrical cord or cable 42 electrically connecting the electrical receptacle 40 to the electrical port 12 of the electrical extension cord device 10.

The electrical connectors 22, 40 in the electrical extension cord device 10 can be varied or altered, respectively, to provide a female and male electrical connectors instead of the male connector 22 and female connector 40 shown in the figures.

The electrical receptacle 40 includes an X-shaped protrusion 40d along with a wire sleeve 40e having slots 40f to make the wire sleeve 40e flexible or bendable. The X-shaped protrusion 40d allows a user to firmly grip the receptacle 40 on both sides of the receptacle 40 using his or her fingers and thumb at surfaces 40g, and then pushing or pulling on the receptacle 40, held stationary, to respectively connect or disconnect the electrical receptacle 40 with a another electrical connector (e.g. plug).

### Waterproof Receptacle

It is important and necessary to make the receptacle 16 waterproof, and to maintain the receptacle 16 and plug 22 free of water and moisture to avoid a user being accidentally shocked by an electrical short when connecting or disconnecting the plug 22, as shown in FIG. 1. Thus, it is important that the cap or cover 32 properly seal with the flange 14 of the electrical port 12. Further, in the event water or moisture enters or condenses within the receptacle 16, it is important that the receptacle drains such water or moisture via a drain. Thus, the receptacle 16 is provided with a drain 18a (e.g. drain hole) located at a lowest point within the receptacle 16 so that the water or moisture drains by gravity flow.

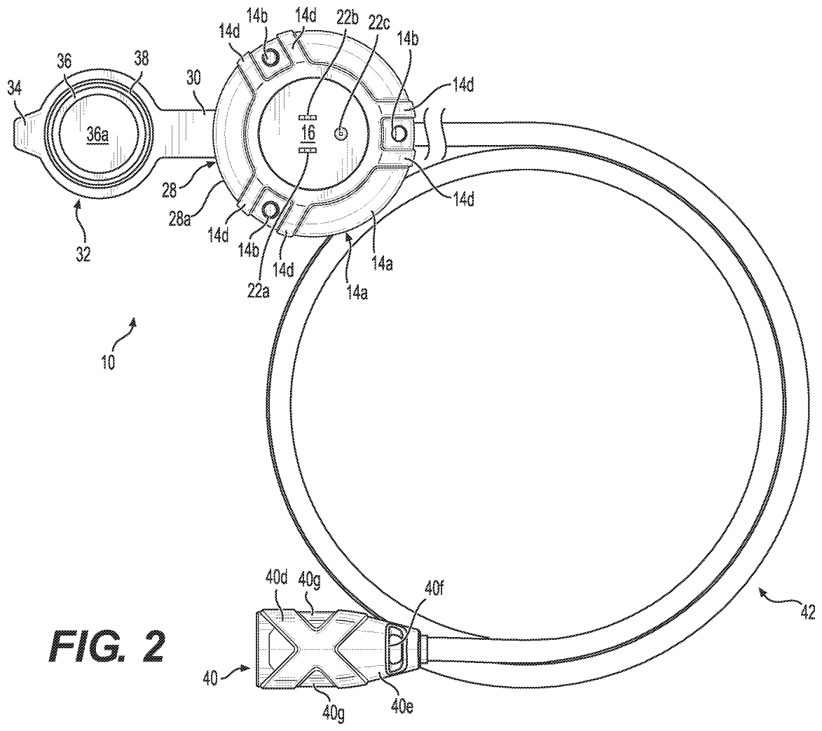

In order to properly seal the receptacle 16 water tight, the flange 14 is provided with a circular-shaped ridge 14c having an inner diameter D1 (FIG. 1) equal to or same as the diameter D1 of the receptacle 16 and an outer diameter D2 greater than the inner diameter D1 of the circular-shaped ridge 14c, and D2 is less than the outer diameter D3 of the flange 14. The flange 14 is also provided with radial ridges 14d extending radially outwardly from the outer edge of the circular-shaped ridge 14c. A pair of ridges 14d are located adjacent to the sides of each through hole 14b (FIG. 2).

The circular-shaped ridge 14c is provided with a flat sealing face 14ca (FIG. 1). The circular-shaped ridge 14c is raised above the outer face 14a of the flange 14 a predetermined height. Further, the radial ridges 14d are raised above the outer face 14a of the flange 14 a predetermined height that is less than the predetermined height of the circular-shaped ridge 14c. This arrangement allows for the inner circular-shaped flat sealing surface 32a of the cap or cover 32 to only seat with the flat face 14ca of the circular-shaped ridge 14c to ensure a good seal therebetween. Specifically, this flat-on-flat sealing arrangement between the circular-shaped flat sealing surface 32a of the cap or cover 32 and flat face 14ca of the flange 14 of the electrical port 12 enhances the ability to seal and waterproof the receptacle 16 and plug 22 to keep water and moisture out of the receptacle 16 and plug 22.

In addition, the ring-shaped ridges 38 of the cap or cover 32 are sized (e.g. predetermined diameter) and designed (e.g. specific profile or cross-sectional shape of ridges 38) so that outer edges of the ridges 38 closely fit and resiliently fit into the inner edge of the receptacle 16. For example, the multiple ridges 38 (e.g. two or more ridges) are used to provide multiple sealing engagements with, for example, a smooth inner cylindrical-shaped sealing surface 18 of receptacle 16. The ring-shaped ridges 38, for example, can have a square-shaped or rectangular-shaped profile to provide flat arcuate sealing edges that sealingly engaging the smooth inner cylindrical-shaped sealing surface 18 of the receptacle 16.

Further, the housing 15 and flange 14 of the electrical port 12 can be injection molded of rigid or semi-rigid plastic material, and the cap or cover 32 can be molded of softer and/or more resilient plastic or rubber material so that the smooth inner cylindrical-shaped sealing surface 18 exerts a band stress onto the ring-shaped outer edges 38a of the ridges 38 to increase the sealing strength of the cap or cover 32 installed “on” to flange 14 of the electrical port 12 of the electrical extension cord device 10.

The cap or cover 32 and ring-shaped ridges 38 can be designed so that a retaining/sealing force is developed between the ridges 38 and inner cylindrical-shaped surface 18 of the receptacle 16 to tightly seal and retain the cap or cover 32 within the receptacle 16. Further, the retaining force applies a sealing force between the sealing surface 38a of the cap or cover 38 and the flat sealing face 14ca of the circular-shaped ridge 14c of the flange 14 of the electrical port 12 of the electrical extension cord device 10.

For example, the cap or cover 38 can be made of resilient plastic or rubber material so that when collar 36 of the cap or cover 32 is fully inserted into the receptacle 16, a user can press on the center of the cap or cover 32 with his or her finger or thumb to even further insert the collar 36 into the receptacle 16 so that the collar 36 applies a resilient retaining force on the cap or cover 32, which applies a resilient sealing force between the inner circular-shaped flat sealing surface 32a of the cap or cover 32 and the flat face 14ca of the circular-shaped ridge 14c to enhance the sealing force there between, which is then maintained.

### Electrical Extension Cord or Cable

The electrical extension cord device 10 comprises an electrical extension cord or cable 42. The extension cord or cable can configured with two (2), three (3), four (4) or more wires, for example, insulated conductive wires. For example, the electrical extension cord device 10 comprises an active wire, neutral wire, and an earth wire. Further, the electrical cord extension cord or cable 42 can comprise multiple set of wires (e.g. two (2) three wire sets). In addition, the electrical port can be provided with multiple electrical connectors (e.g. two or more plugs, two or more receptacles, power bar(s)), and the electrical connector can include multiple connectors (e.g. two or more plugs, two or more receptacles). Even further, the electrical extension cord device can include a fuse, on-off switch, one or more LEDs (e.g. lights up when power “on” mode, red LED to indicate power “on” mode), or LEDs providing night lighting (e.g. ribbon LEDs) or a flash light feature.

The electrical cord or cable connector 50 is provided with a protrusion 50d to enhance gripping of the cord or cable connector between a user's fingers and/or thumb.

The electrical connector (e.g. receptacle 40), for example, is made of resilient plastic material injection molded with electrical conductor 40a, 40b, 40c (e.g. neutral, active, earth conductors).

1. An electrical extension cord or cable device, comprising:
an electrical port having a housing provided with a receptacle and a flange surrounding the receptacle;
a cover removable disposed within the receptacle to cover and uncover the plug;
an electrical plug disposed within the receptacle;
an electrical connector; and
an electrical extension cord or cable electrically connecting together the electrical port and the electrical connector.

2. An electrical extension cord or cable device, comprising:
an electrical port having a housing provided with a receptacle and a flange surrounding the receptacle;
an electrical plug disposed within the receptacle;
a cover removable disposed within the receptacle to cover and uncover the plug;
an electrical connector; and
an electrical extension cord or cable electrically connecting together the electrical port and the electrical connector.

3. An electrical extension cord or cable device, comprising:
an electrical port having a housing provided with a receptacle and a flange surrounding the receptacle;
an electrical plug disposed within the receptacle;
a cover removable disposed within the receptacle to cover and uncover the plug;
an electrical receptacle;
an extension cord or cable electrically connecting together the electrical port and the electrical receptacle.

4. The device according to claim 1, wherein the electrical connector is provided with one or more slots to provide a flexible connection with the electrical extension cord or cable.

5. The device according to claim 1, wherein the electrical connector is provided with a protrusion to enhance gripping of the electrical cord or cable connector by a user.

6. The device according to claim 1, wherein the flange has a circular-shaped sealing ridge and the cover includes an inner circular-shaped sealing surface for sealingly cooperating with the circular-shaped sealing ridge of the flange of the electrical port.

7. The device according to claim 6 wherein the circular-shaped sealing ridge of the flange of the electrical port is provided with a flat sealing face.

8. The device according to claim 6, wherein the flat sealing face of the circular-shaped sealing ridge is elevated a predetermined distance above an outer face of the flange of the electrical port.

9. The device according to claim 1, further comprising a gasket provided on an inner side of the flange of the electrical port.

10. The device according to claim 9, wherein the cover or cap is connected to the gasket.

11. The device according to claim 10, wherein the cover or cap is connected to the gasket by a flexible connector.

12. The device according to claim 11, wherein the cover, gasket, and flexible connector are constructed as a single piece.

13. The device according to claim 1, wherein the cover comprises a collar for fitting into the receptacle of the electrical port.

14. The device according to claim 13, wherein the collar comprises one or more outer ridges.

15. The device according to claim 1, wherein the housing is provided with a venting and/or drain hole.

16. The device according to claim 1, wherein the extension cord is at least three (3) feet in length.

17. The device according to claim 1, wherein the extension cord is at least one (1) meter in length.
